(19) United States
(12) Patent Application Publication
(10) Pub. No.: US 2015/0002918 A1
(43) Pub. Date: Jan. 1, 2015

(54) WAVELENGTH SWEPT SOURCE APPARATUS AND CONTROLLING METHOD THEREOF

(71) Applicant: ELECTRONICS AND TELECOMMUNICATIONS RESEARCH INSTITUTE, DAEJEON (KR)

(72) Inventors: Oh Kee KWON, Daejeon (KR); Chul-Wook LEE, Daejeon (KR); Young-Tak HAN, Daejeon (KR); Jang Uk SHIN, Daejeon (KR); Minhyup SONG, Gyeonggi-do (KR); Kwang Ryong OH, Daejeon (KR)

(73) Assignee: ELECTRONICS AND TELECOMMUNICATIONS RESEARCH INSTITUTE, DAEJEON (KR)

(21) Appl. No.: 14/148,086

(22) Filed: Jan. 6, 2014

(30) Foreign Application Priority Data
Jun. 26, 2013 (KR) 10-2013-0073721

(51) Int. Cl. G02F 1/35

(52) U.S. Cl. CPC G02F 1/3532
USPC 359/239; 359/278

(57) ABSTRACT

Provided are a wavelength swept source apparatus and a method for controlling thereof. According to the provided apparatus and method, single mode light is generated, a basic optical comb is generated by modulating the generated single mode light, and a plurality of optical combs having different a frequency band from that of the basic optical comb is generated by modulating the plurality of light rays. The plurality of light rays and light rays included in the plurality of optical combs are sequentially emitted according to frequencies of the plurality of light rays and the light rays included in the plurality of optical combs. A value of a control variable is adjusted based on a characteristic of the generated single mode light, the plurality of light rays, the light rays included in the plurality of optical combs, and the emitted light rays.

### CROSS-REFERENCE TO RELATED APPLICATIONS

This U.S. non-provisional patent application claims priority under 35 U.S.C. §119 of Korean Patent Application No. 10-2013-0073721, filed on Jun. 26, 2013, the entire contents of which are hereby incorporated by reference.

### BACKGROUND OF THE INVENTION

1. Technical Field

The inventive concept relates to a wavelength tunable light source apparatus, and more particularly, to a wavelength swept source apparatus for sequentially and rapidly emitting a plurality of rays having different frequencies and a controlling method thereof.

2. Description of Related Art

A wavelength swept source apparatus sequentially emits a plurality of rays having different frequencies. The wavelength swept source apparatus is used in various fields such as the fields of a real-time optical coherent tomography (OCT) instrument for monitoring an industrial process, a medical three-dimensional OCT instrument, a light source for optical communication, a semiconductor analyzer, a polymer analysis spectrometer, and a light source for an environmental gas monitoring apparatus.

The wavelength swept source apparatus may be construed as one type of a wavelength tunable light source apparatus, in a broad sense. The wavelength swept source apparatus may be classified into a bulk optics type, a fiber optics type, and a semiconductor integrated optical element type, according to a type of a resonator. According to the bulk optics type apparatus, a wavelength of light may be changed within an optical gain bandwidth of a light source, a resonator may be easily implemented, and an optical loss is small. However, the bulk optics type apparatus needs precise optical alignment and has a large volume. Moreover, the bulk optics type apparatus has low reliability due to its strong mechanical vibration.

According to the fiber optics type apparatus, the wavelength swept source apparatus may be implemented in various configurations and forms according to linear or nonlinear characteristics of an optical fiber. However, the fiber optics type apparatus has a large volume and includes a large number of components, accordingly, has high unit cost of the apparatus. Furthermore, when a frequency of light outputted from the fiber optics type apparatus varies rapidly, intensity of the output light is reduced and linewidth of the output light is broadened.

The semiconductor integrated optical element type apparatus has a small volume and high reliability, and may be manufactured cost-effectively. However, according to the semiconductor integrated optical element type apparatus, an oscillation mode may be discontinuously switched while a wavelength is tuned, i.e., a mode hopping phenomenon may occur. Moreover, according to the semiconductor integrated optical element type apparatus, a method to change a frequency is complicated.

In the past, each of the above-mentioned implementation types had distinctly different performance, advantages, and disadvantages. Thus, each of the implementation types was applied to different fields. However, according to the development of implementation technology and the improvement of apparatus performance, the limitations of each of the implementation types have been recently overcome. Accordingly, the fields to which each of the implementation types are applied overlap with each other.

The OCT or automatic optical inspection (AOI) system using the wavelength swept source apparatus needs to provide a high-definition image in real time. In these systems, an apparatus for rapidly changing a frequency of output light should be used. A tuning rate of about 1 MHz or higher is required so that these systems provide at least five sheets of a high-definition three-dimensional image per second. However, the typical implementation types have limitations in terms of a frequency changing speed of output light and operation stability. Thus, the typical implementation types have a tuning rate of several tens to several hundreds of kHz.

### SUMMARY OF THE INVENTION

The inventive concept provides a wavelength swept source apparatus having a different structure from that of a typical wavelength swept source apparatus, and a method for controlling thereof. According to an embodiment of the inventive concept, limitations of the typical wavelength swept source apparatus may be overcome. That is, the wavelength swept source apparatus according to the inventive concept may sequentially emit a plurality of light rays having different frequencies stably and rapidly. Furthermore, according to the inventive concept, the wavelength swept source apparatus may be controlled so that wavelength sweeping is appropriately performed.

One embodiment of the inventive concept may provide wavelength swept source apparatuses including: a light source configured to generate single mode light; an optical comb generation unit configured to generate a basic optical comb comprising a plurality of light rays having identical frequency differences with adjacent light rays by modulating the generated single mode light; a frequency band extension unit configured to generate a plurality of optical combs by modulating the plurality of light rays, wherein each of the plurality of optical combs comprises same number of light rays as the plurality of light rays, each of the same number of light rays has identical frequency differences with adjacent light rays, each of the plurality of optical combs does not overlap the basic optical comb and has a different frequency band from that of the basic optical comb, and the plurality of optical combs is distributed in a wider frequency band than that in which the basic optical comb is distributed; a light emission unit configured to sequentially emit the plurality of light rays and light rays included in the plurality of optical combs according to frequencies of the plurality of light rays and the light rays included in the plurality of optical combs; a control unit configured to adjust a value of a control variable for at least one of the light source, the optical comb generation unit, the frequency band extension unit, and the light emission unit, based on a characteristic of light outputted from at least one of the light source, the optical comb generation unit, the frequency band extension unit, and the light emission unit.

In one embodiment, the wavelength swept source apparatus may further include: an optical coupler configured to split output light of at least one of the optical comb generation unit and the light emission unit; and an optical detector configured to transform intensity of the split output light into an electric signal, wherein the control unit adjusts a value of a current provided to the light source based on the transformed electric signal.

In one embodiment, the wavelength swept source apparatus may further include an optical amplifier or optical attenuator configured to adjust intensity of output light of the optical comb generation unit. The wavelength swept source apparatus according to this embodiment may further include: an optical coupler configured to split output light of at least one of the optical amplifier or optical attenuator and the light emission unit; an optical detector configured to transform intensity of the split output light into an electric signal, wherein the control unit adjusts a gain value of the optical amplifier or optical attenuator based on the transformed electric signal.

In one embodiment, the wavelength swept source apparatus may further include: an optical coupler configured to split output light of the frequency band extension unit; and an optical spectrum analyzer configured to calculate a frequency band in which the split output light is distributed, wherein the control unit adjusts at least one of a value of a current provided to the light source, a value of a voltage applied to the optical comb generation unit, and a modulation frequency that determines the voltage applied to the optical comb generation unit, based on the calculated frequency band.

In one embodiment, the wavelength swept source apparatus may further include: an optical coupler configured to split output light of the light emission unit; and a real-time scope or linewidth measuring instrument configured to calculate an interval between a time at which light having the highest frequency is emitted from the optical coupler and a time at which light having the lowest frequency is emitted from the optical coupler, wherein the control unit adjusts modulation signal width that determines a voltage applied to the optical comb generation unit, based on the calculated interval.

In one embodiment, the light emission unit may include a dispersion controller configured to adjust an interval between each time at which each of the plurality of light rays and the light rays included in the plurality of optical combs is emitted. The wavelength swept source apparatus according to these embodiments may further include: an optical coupler configured to split output light of the dispersion controller; and a real-time scope or linewidth measuring instrument configured to calculate an interval between a time at which a light ray having the highest frequency is emitted from the optical coupler and a time at which a light ray having the lowest frequency is emitted from the optical coupler, wherein the control unit adjusts a value of a voltage applied to the dispersion controller based on the calculated interval.

Other embodiment of the inventive concept may provide a method for controlling a wavelength swept source apparatus including: generating single mode light; generating a basic optical comb comprising a plurality of light rays having identical frequency differences with adjacent light rays by modulating the generated single mode light; generating a plurality of optical combs by modulating the plurality of light rays, wherein each of the plurality of optical combs comprises same number of light rays as the plurality of light rays, each of the same number of light rays has identical frequency differences with adjacent light rays, each of the plurality of optical combs does not overlap the basic optical comb and has a different frequency band from that of the basic optical comb, and the plurality of optical combs is distributed in a wider frequency band than that in which the basic optical comb is distributed; sequentially emitting the plurality of light rays and light rays included in the plurality of optical combs according to frequencies of the plurality of light rays and the light rays included in the plurality of optical combs; determining whether a characteristic of at least one of the generated single mode light, the plurality of light rays, the light rays included in the plurality of optical combs, and the emitted light rays reaches a target value; and adjusting a value of a control variable for at least one of the generated single mode light, the plurality of light rays, the light rays included in the plurality of optical combs, and the emitted light rays, if the characteristic of at least one of the generated single mode light, the plurality of light rays, the light rays included in the plurality of optical combs, and the emitted light rays does not reach the target value.

In other embodiment, the determining may include determining whether intensity of at least one of the plurality of light rays and the emitted light rays reaches the target value, and the adjusting may include adjusting at least one of a value of a current for controlling an output of the generated single mode light and a gain value for controlling the intensity of the plurality of light rays.

In other embodiment, the determining may include determining whether a frequency band in which the plurality of light rays and the light rays included in the plurality of optical combs is distributed reaches the target value, and the adjusting may include adjusting at least one of a value of a current for controlling an output of the generated single mode light, a value of a voltage for controlling an output of the plurality of light rays, and a modulation frequency that determines the voltage for controlling the output of the plurality of light rays.

In other embodiment, the determining may include determining whether an interval between a time at which a light ray having the highest frequency among the emitted light rays is emitted and a time at which a light ray having the lowest frequency among the emitted light rays is emitted reaches the target value, and the adjusting may include adjusting at least one of modulation signal width that determines a voltage for controlling an output of the plurality of light rays and an interval between each time at which each of the emitted light rays is emitted.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram illustrating a configuration of a wavelength swept source apparatus according to an embodiment of the inventive concept;

FIG. 2 is a conceptual diagram illustrating a configuration of an optical comb generation unit that may be included in an embodiment of the inventive concept;

FIG. 3 is a conceptual diagram illustrating other configuration of an optical comb generation unit that may be included in an embodiment of the inventive concept;

FIG. 4 is a graph illustrating a characteristic of light outputted from an optical comb generation unit that may be included in an embodiment of the inventive concept;

FIG. 5 is a graph illustrating a characteristic of light outputted from a frequency band extension unit that may be included in an embodiment of the inventive concept;

FIG. 6 is a graph illustrating a characteristic of light emitted from a light emission unit that may be included in an embodiment of the inventive concept;

FIGS. 7 to 11 are block diagrams illustrating other configurations of a wavelength swept source apparatus according to an embodiment of the inventive concept;

FIG. 12 is a graph illustrating a characteristic of light outputted from a dispersion controller that may be included in an embodiment of the inventive concept;

FIGS. 13 and 14 are block diagrams illustrating another configurations of a wavelength swept source apparatus according to an embodiment of the inventive concept;

FIG. 15 is a graph illustrating a characteristic of a voltage applied to an optical comb generation unit and a characteristic of light emitted from a light emission unit according to an embodiment of the inventive concept;

FIG. 16 is a flowchart illustrating a method for controlling a wavelength swept source apparatus according to other embodiment of the inventive concept;

FIG. 17 is a detailed flowchart illustrating a method for controlling a wavelength swept source apparatus according to other embodiment of the inventive concept;

FIG. 18 is other detailed flowchart illustrating a method for controlling a wavelength swept source apparatus according to other embodiment of the inventive concept; and

FIG. 19 is another detailed flowchart illustrating a method for controlling a wavelength swept source apparatus according to other embodiment of the inventive concept.

### DETAILED DESCRIPTION OF PREFERRED EMBODIMENTS

The above-described characteristics and the following detailed description are merely examples for helping the understanding of the inventive concept. That is, the inventive concept may be embodied in different forms and should not be constructed as limited to the embodiments set forth herein. The following embodiments are merely examples for completely disclosing the inventive concept and for delivering the inventive concept to those skilled in the art that the inventive concept belongs. Therefore, in the case where there are multiple methods for implementing the elements of the inventive concept, the inventive concept may be implemented with any of the methods or an equivalent thereof.

When it is mentioned that a certain configuration includes a specific element or a certain process includes a specific step, another element or another step may be further included. That is, the terms used herein are not for limiting the concept of the inventive concept, but for describing a specific embodiment. Furthermore, the embodiments described herein include complementary embodiments thereof.

The terms used herein have meanings that are generally understood by those skilled in the art. The commonly used terms should be consistently interpreted according to the context of the specification. Furthermore, the terms used herein should not be interpreted as overly ideal or formal meanings, unless the meanings of the terms are clearly defined. Hereinafter, the embodiments of the inventive concept will be described with reference to the accompanying drawings.

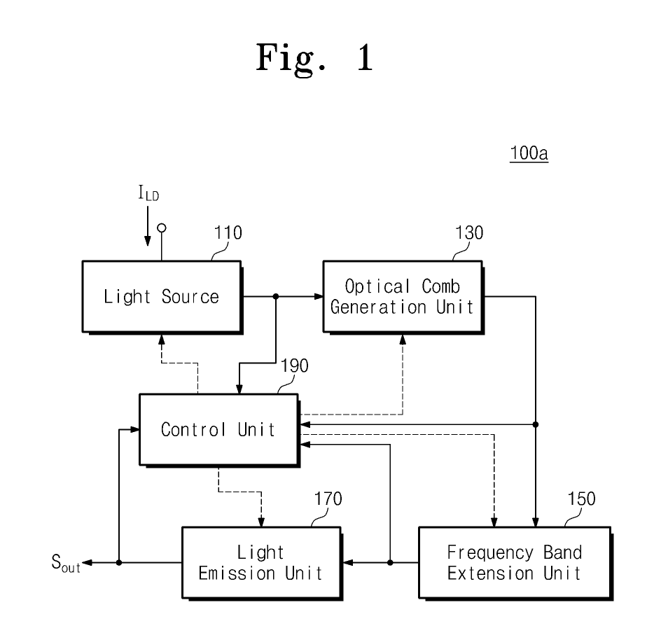

FIG. 1 is a block diagram illustrating a configuration of a wavelength swept source apparatus according to an embodiment of the inventive concept. A wavelength swept source apparatus 100a includes a light source 110, an optical comb generation unit 130, a frequency band extension unit 150, a light emission unit 170, and a control unit 190.

The light source 110 may generate single mode light. The light source 110 may be a longitudinal single mode laser diode for generating a laser having a single frequency. In this case, the light source 110 may operate by being supplied with a laser diode current I_{LD}, and generate the single mode light. In FIG. 1, it is assumed that the light source 110 is the longitudinal single mode laser diode operating by being supplied with the laser diode current. This assumption is not for limiting the scope of the inventive concept, but for illustrating the inventive concept. That is, the light source 110 may have any form for generating the single mode light.

The optical comb generation unit 130 may be provided with the single mode light generated by the light source 110. The optical comb generation unit 130 may generate a basic optical comb by modulating the single mode light. The basic optical comb includes a plurality of light rays having different frequencies. The plurality of light rays included in the basic optical comb has the same frequency difference with an adjacent light ray.

The optical comb generation unit 130 may generate the plurality of light rays having different frequencies using a method of mode locking or a method of generating a harmonic wave through phase modulation. Particularly, when the method of generating the harmonic wave is used, a center frequency is determined by a frequency of the single mode light generated by the light source 110, and the frequency of the single mode light is not changed. Furthermore, when the method of generating the harmonic wave is used, a frequency interval between each of the plurality of light rays included in the basic optical comb is determined by a modulation frequency, and thus adjustment of the frequency interval is not difficult. Moreover, when the method of generating the harmonic wave is used, the plurality of light rays included in the basic optical comb may be adjusted to have a uniform intensity, based on an amount of phase change and phase difference. That is, the method of generating the harmonic wave may be more useful than the method of mode locking.

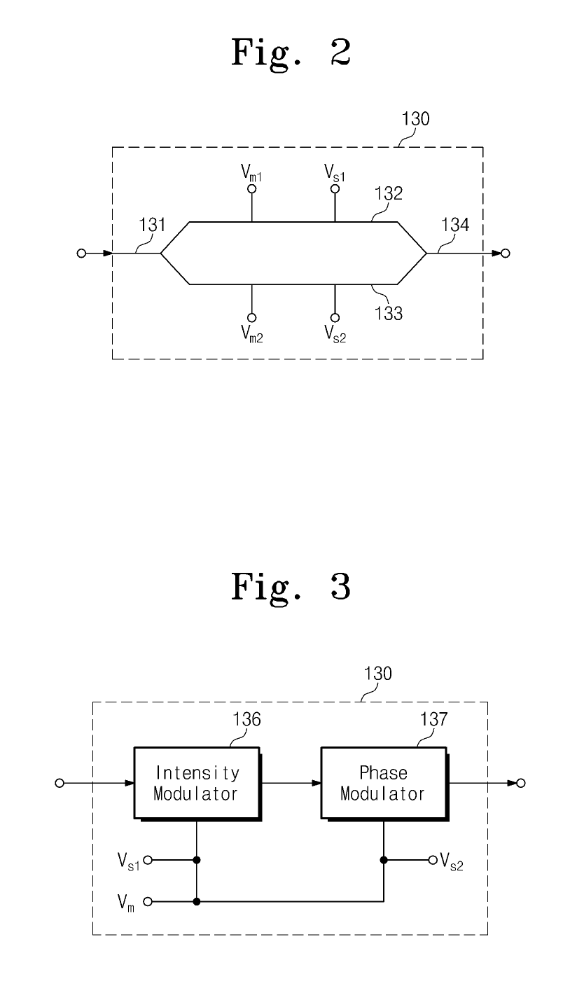

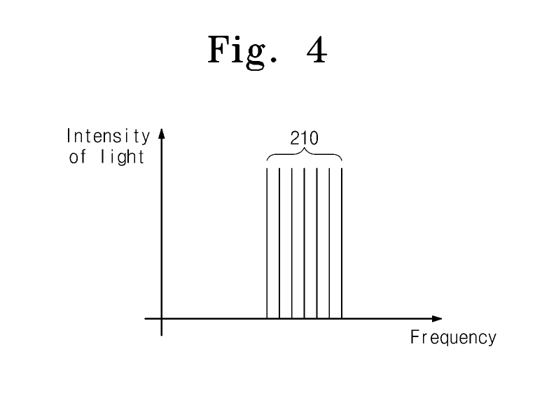

A conceptual configuration of the optical comb generation unit 130 using the method of generating the harmonic wave will be described later with reference to FIGS. 2 and 3. A characteristic of the plurality of light rays included in the basic optical comb will be described in more detail with reference to FIG. 4.

The frequency band extension unit 150 may be provided with the basic optical comb generated by the optical comb generation unit 130. The frequency band extension unit 150 may generate a plurality of optical combs by modulating the basic optical comb. Each of the plurality of optical combs includes light rays, the number of which is the same as that of the plurality of light rays included in the basic optical comb.

The light rays included in each of the plurality of optical combs have the same frequency difference with an adjacent light ray. There is a one-to-one correspondence between the light rays included in each of the plurality of optical combs and the plurality of light rays included in the basic optical comb. Frequency difference between a first light ray and a second light ray adjacent to the first light ray, among the plurality of light rays included in the basic optical comb, is the same as frequency difference between a light ray corresponding to the first light ray and a light ray corresponding to the second light ray, among the light rays included in each of the plurality of optical combs.

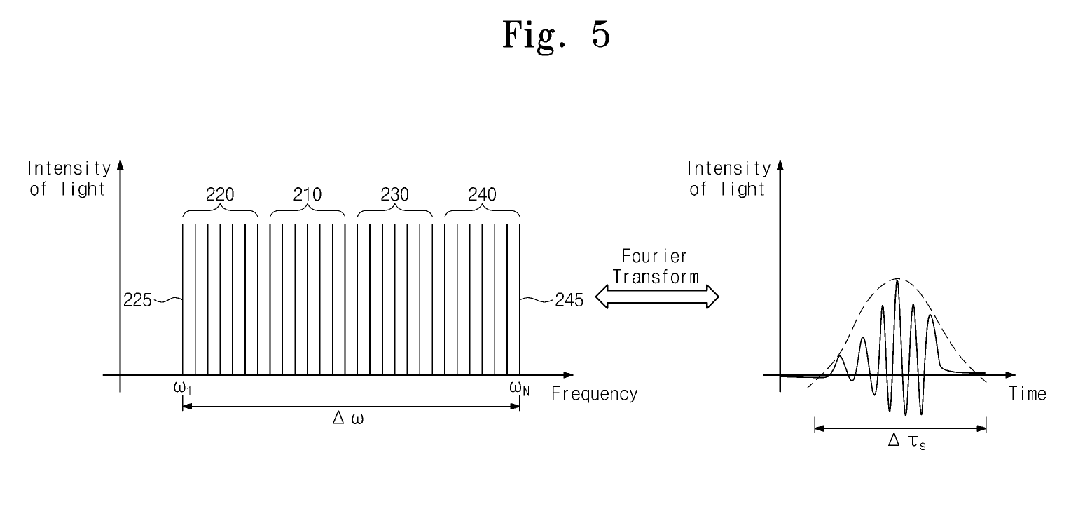

A frequency band in which the plurality of light rays included in the basic optical comb are distributed and a frequency band in which the light rays included in each of the plurality of optical combs are distributed do not overlap each other. As a result, the plurality of optical combs may be distributed in a wider frequency band than that in which the basic optical comb is distributed. An output of the frequency band extension unit 150 may seem as if the basic optical comb has been extended over a wider frequency band. The frequency band extension unit 150 may be formed of a medium exhibiting a four-wave mixing phenomenon or a medium having a nonlinear characteristic such as self-phase modulation characteristic. A characteristic of the plurality of light rays included in the basic optical comb and the light rays included in each of the plurality of optical combs will be described in more detail with reference to FIG. 5.

The light emission unit 170 may be provided with the basic optical comb and the plurality of optical combs generated by the frequency band extension unit 150. The light emission unit 170 may sequentially emit the plurality of light rays included in the basic optical comb and the light rays included in each of the plurality of optical combs, i.e., Sₒᵤₜ. The light emission unit 170 may sequentially emit the light rays according to the frequencies thereof. For instance, the light emission unit 170 may sequentially emit the light rays using a group velocity dispersion characteristic of a medium.

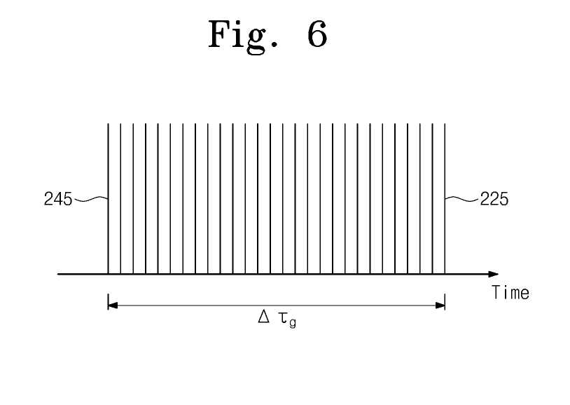

A typical optical fiber has such a characteristic that a dispersion coefficient is changed according to an operating frequency. Therefore, when a plurality of light rays having different frequencies is transmitted through the optical fiber, the light rays are emitted with an interval of time. Additionally, the interval between each time at which each of the light rays is emitted may be adjusted by adjusting the length of the optical fiber. A characteristic of the sequentially emitted light rays will be described in more detail with reference to FIG. 6.

The control unit 190 may be provided with a characteristic of light outputted from at least one of the light source 110, the optical comb generation unit 130, the frequency band extension unit 150, and the light emission unit 170. That is, the control unit 190 may be provided with a characteristic of at least one of the single mode light, the basic optical comb, the plurality of optical combs, and the sequentially emitted light rays. Furthermore, the control unit 190 may adjust a value of a control variable for controlling at least one of the light source 110, the optical comb generation unit 130, the frequency band extension unit 150, and the light emission unit 170, based on the provided characteristic of light.

For example, the control unit 190 may be provided with intensity of light outputted from at least one of the light source 110, the optical comb generation unit 130, the frequency band extension unit 150, and the light emission unit 170. Alternatively, the control unit 190 may be provided with a frequency band in which light rays outputted from at least one of the optical comb generation unit 130 and the frequency band extension unit 150 are distributed. Alternatively, the control unit 190 may be provided with an interval between a time at which a light ray having the highest frequency is emitted from the light emission unit 170 and a time at which a light ray having the lowest frequency is emitted from the light emission unit 170. Here, the above-mentioned characteristics of light are merely exemplary characteristics of light that may be provided to the control unit 190. That is, the control unit 190 may be provided with other optical characteristics that are performance indices of the wavelength swept source apparatus 100a.

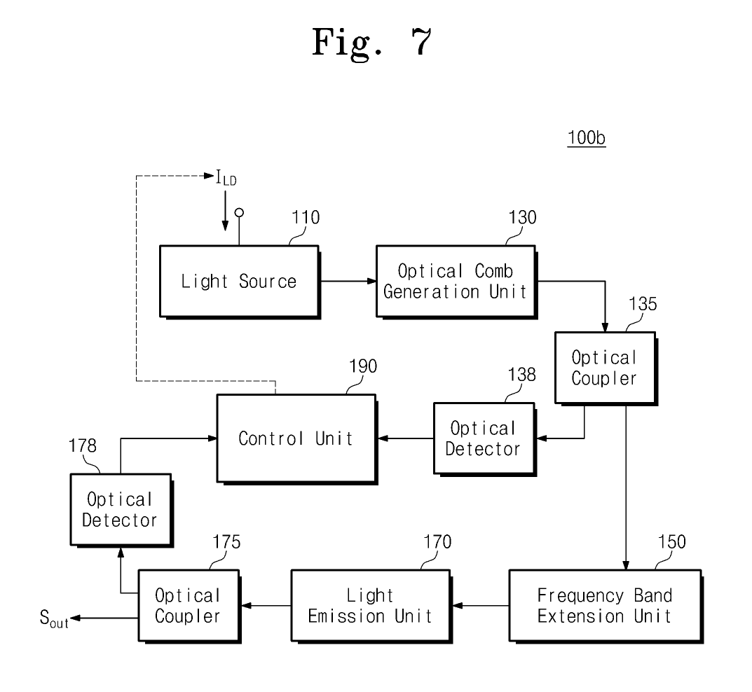

For example, a control variable for controlling the light source 110 may include a laser diode current. For example, a control variable for controlling the optical comb generation unit 130 may include a modulation voltage, a modulation frequency, and a modulation signal width. The control unit 190 may adjust at least one of a value of the laser diode current, a value of the modulation voltage, the modulation frequency, and the modulation signal width, based on the provided characteristics of light. The foregoing control variables are merely examples of variables for controlling each of the components. That is, each of the components may be controlled by other variables. A process of adjusting a value of the control variable, by the control unit, based on the characteristic of light will be described in more detail with reference to FIGS. 7 to 10, 13, 14, and 16 to 19.

FIG. 2 is a conceptual diagram illustrating a configuration of an optical comb generation unit that may be included in an embodiment of the inventive concept. Particularly, FIG. 2 illustrates a case where the optical comb generation unit 130 includes a double electrode Mach-Zehnder modulator (DEMZM).

The DEMZM of the optical comb generation unit 130 may include an input light waveguide 131, a first modulation unit 132, a second modulation unit 133, and an output light waveguide 134. The input light waveguide 131 may be provided with the single mode light generated by the light source 110 (refer to FIG. 1). A first modulation voltage Vₘ₁ and a first static voltage Vₛ₁ for phase control may be applied to the first modulation unit 132. A second modulation voltage Vₘ₂ and a second static voltage Vₛ₂ for phase control may be applied to the second modulation unit 133. According to modulation results of the first modulation unit 132 and the second modulation unit 133, the output light waveguide 134 may generate the basic optical comb. The basic optical comb includes a plurality of light rays having different frequencies.

The optical comb generation unit 130 including the DEMZM may be formed by a light waveguide structure, which is composed of a semiconductor material, a polymer material, or LiNO₃. Alternatively, the optical comb generation unit 130 including the DEMZM may be integrated on the same substrate as that of the light source 110.

FIG. 3 is a conceptual diagram illustrating other configuration of an optical comb generation unit that may be included in an embodiment of the inventive concept. Particularly, FIG. 3 illustrates a case where the optical comb generation unit 130 includes an intensity modulator 136 and a phase modulator 137 connected to each other in series.

The single mode light generated by the light source 110 (refer to FIG. 1) may be provided to the intensity modulator 136. The phase modulator 137 may receive a modulation result of the intensity modulator 136 and may generate the basic optical comb. The basic optical comb includes a plurality of light rays having different frequencies. A modulation voltage Vₘ, a first static voltage Vₛ₁ for phase control, and a second static voltage Vₛ₂ for phase control may be applied to the intensity modulator 136 and the phase modulator 137.

The optical comb generation unit 130 including the intensity modulator 136 and the phase modulator 137 connected in series may be formed by a light waveguide structure, which is composed of a semiconductor material, a polymer material, or LiNO₃. Alternatively, the optical comb generation unit 130 including the intensity modulator 136 and the phase modulator 137 connected in series may be integrated on the same substrate as that of the light source 110. The optical comb generation unit 130 of FIG. 3 includes single intensity modulator 136 and single phase modulator 137. However, the optical comb generation unit 130 may include a plurality of intensity modulators and a plurality of phase modulators in order to improve a form of the basic optical comb outputted from the optical comb generation unit 130.

The configurations described above with reference to FIGS. 2 and 3 are merely exemplary configurations that the optical comb generation unit 130 may have. The configuration of the optical comb generation unit 130 is not limited to the configurations illustrated in FIGS. 2 and 3. The optical comb generation unit 130 may have a different configuration from the configurations illustrated in FIGS. 2 and 3.

FIG. 4 is a graph illustrating a characteristic of light outputted from an optical comb generation unit that may be included in an embodiment of the inventive concept. That is, a characteristic of the plurality of light rays included in the basic optical comb is described with reference to FIG. 4.

When the single mode light generated by the light source 110 (refer to FIG. 1) is modulated by the optical comb generation unit 130 (refer to FIG. 1), a plurality of light rays may be generated. The plurality of generated light rays may form a basic optical comb 210. The plurality of light rays included in the basic optical comb 210 has different frequencies. When the method of generating the harmonic wave is used by the optical comb generation unit 130, the plurality of light rays may be adjusted to have a uniform intensity according to an amount of phase change and phase difference. However, FIG. 4 merely illustrates an example of the characteristic of the plurality of light rays included in the basic optical comb 210. The number of light rays, the intensity of light rays, and a frequency interval may be changed according to a setting for the optical comb generation unit 130.

FIG. 5 is a graph illustrating a characteristic of light outputted from a frequency band extension unit that may be included in an embodiment of the inventive concept. That is, a characteristic of the plurality of light rays included in the basic optical comb and the light rays included in each of the plurality of optical combs is described with reference to FIG. 5.

When the basic optical comb 210 generated by the optical comb generation unit 130 (refer to FIG. 1) is modulated by the frequency band extension unit 150 (refer to FIG. 1), a plurality of optical combs 220, 230, and 240 may be generated. The basic optical comb 210 may form, together with the plurality of optical combs 220 to 240, an optical comb distributed in a wider frequency band Δω.

Each of the plurality of optical combs 220 to 240 includes light rays, the number of which is the same as that of the plurality of light rays included in the basic optical comb 210. The light rays included in each of the plurality of optical combs 220 to 240 have the same frequency difference with an adjacent light ray. There is a one-to-one correspondence between the light rays included in each of the plurality of optical combs 220 to 240 and the plurality of light rays included in the basic optical comb 210. A frequency band in which the plurality of light rays included in the basic optical comb 210 are distributed and a frequency band in which the light rays included in each of the plurality of optical combs 220 to 240 are distributed do not overlap each other.

Frequency difference between a first light ray and a second light ray adjacent to the first light ray, among the plurality of light rays included in the basic optical comb 210, is the same as frequency difference between a light ray corresponding to the first light ray and a light ray corresponding to the second light ray, among the light rays included in each of the plurality of optical combs 220 to 240. The plurality of light rays included in the basic optical comb 210 and the light rays included in each of the plurality of optical combs 220 to 240 have different frequencies. One of the basic optical comb 210 and the plurality of optical combs 220 to 240 includes a light ray 225 having the lowest frequency ω₁ or a light ray 245 having the highest frequency ω_{N}.

An output of the frequency band extension unit 150 has a wavelet waveform in time domain. The output of the frequency band extension unit 150 has an envelope of a time width Δτₛ which is inversely proportional to a linewidth of an optical comb in time domain. However, FIG. 5 merely illustrates an example of the characteristic of the plurality of light rays included in the basic optical comb 210 and the light rays included in each of the plurality of optical combs 220 to 240. The number of light rays, the intensity of light rays, and a frequency interval may be changed according to a setting for the frequency band extension unit 150.

FIG. 6 is a graph illustrating a characteristic of light emitted from a light emission unit that may be included in an embodiment of the inventive concept. That is, the characteristic of the sequentially emitted light rays is described with reference to FIG. 6.

When the basic optical comb 210 (refer to FIG. 4) generated by the optical comb generation unit 130 (refer to FIG. 1) and the plurality of optical combs 220 to 240 (refer to FIG. 5) generated by the frequency band extension unit 150 (refer to FIG. 1) pass through the light emission unit 170 (refer to FIG. 1), each of light rays included in the basic optical comb 210 and the plurality of optical combs 220 to 240 are sequentially emitted. The light emission unit 170 may sequentially emit the light rays according to the frequencies thereof. That is, the light emission unit 170 may sequentially emit the light rays from the light ray 245 having the highest frequency to the light ray 225 having the lowest frequency in a time sequence.

However, FIG. 6 merely illustrates an example of the characteristic of the sequentially emitted light rays. An interval Δτ_{g} between a time at which the light ray 245 having the highest frequency is emitted and a time at which the light ray 225 having the lowest frequency is emitted, and an interval between each time at which each light ray is emitted may be changed according to a dispersion characteristic of the light emission unit 170.

FIG. 7 is a block diagram illustrating other configuration of a wavelength swept source apparatus according to an embodiment of the inventive concept. A wavelength swept source apparatus 100b includes a light source 110, an optical comb generation unit 130, a frequency band extension unit 150, a light emission unit 170, optical couplers 135 and 175, optical detectors 138 and 178, and a control unit 190. The light source 110, the optical comb generation unit 130, the frequency band extension unit 150, the light emission unit 170, and the control unit 190 have the same structures and functions as the light source 110, the optical comb generation unit 130, the frequency band extension unit 150, the light emission unit 170, and the control unit 190 included in the wavelength swept source apparatus 100a of FIG. 1. Therefore, overlapping descriptions will be omitted.

The optical couplers 135 and 175 may be connected to output terminals of the optical comb generation unit 130 and the light emission unit 170, respectively. The optical couplers 135 and 175 may split output light of the optical comb generation unit 130 and the light emission unit 170, respectively. However, it would be obvious that only one of the optical couplers 135 and 175 may be connected to be used. However, it is assumed herein that both of the optical couplers 135 and 175 are used, in order to help the understanding of the inventive concept. The optical couplers 135 and 175 may be star-type couplers, tree-type couplers, or directional couplers.

The optical detectors 138 and 178 may receive the output light of the optical comb generation unit 130 and the output light of the light emission unit 170, respectively, which have been split by the optical couplers 135 and 175, respectively. The optical detectors 138 and 178 may transform intensity of the output light of the optical comb generation unit 130 and intensity of the output light of the light emission unit 170, respectively, into electric signals. Here, the electric signals obtained through the transformation by the optical detectors 138 and 178 may have a form of at least one of a voltage, a current, and power. Alternatively, the electric signals obtained through the transformation by the optical detectors 138 and 178 may have a form of a digital signal processed by an analog-to-digital (A/D) converter (not shown).

The control unit 190 may receive the electric signals obtained through the transformation by the optical detectors 138 and 178. The control unit 190 may adjust a value of a laser diode current I_{LD} provided to the light source 110, based on the electric signals. As the value of the laser diode current increases, intensity of the output light Sₒᵤₜ of the wavelength swept source apparatus 100b increases.

Therefore, since the value of the laser diode current is adjusted by the control unit 190, the intensity of the output light which is a performance index of the wavelength swept source apparatus 100b may reach a set target value. For example, when the intensity of the output light of the wavelength swept source apparatus 100b is weakened due to optical loss, the control unit 190 may control a current source (not shown), so that the value of the laser diode current is increased.

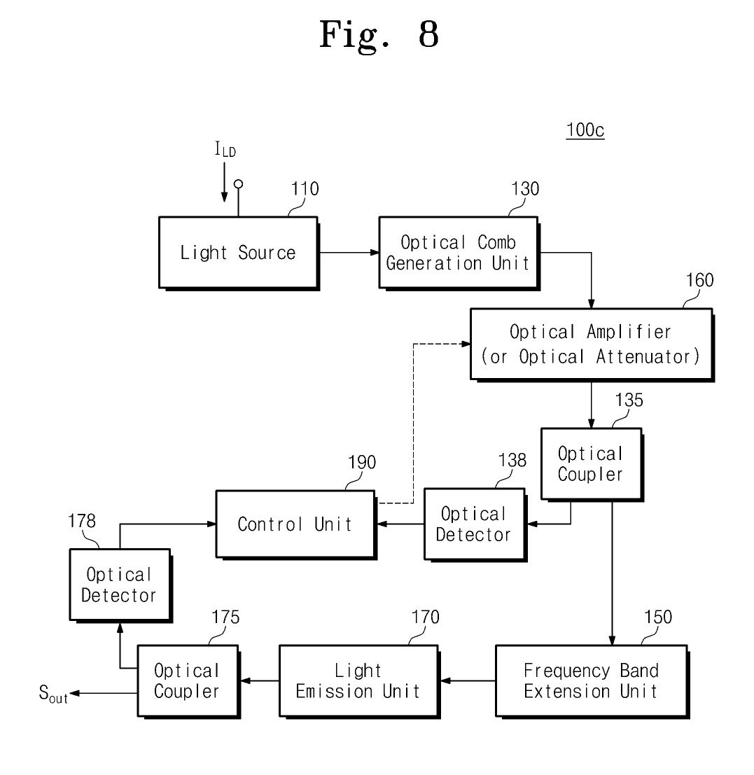

FIG. 8 is a block diagram illustrating other configuration of a wavelength swept source apparatus according to an embodiment of the inventive concept. A wavelength swept source apparatus 100c includes a light source 110, an optical comb generation unit 130, an optical amplifier or optical attenuator 160, a frequency band extension unit 150, a light emission unit 170, optical couplers 135 and 175, optical detectors 138 and 178, and a control unit 190. The light source 110, the optical comb generation unit 130, the frequency band extension unit 150, the light emission unit 170, and the control unit 190 have the same structures and functions as the light source 110, the optical comb generation unit 130, the frequency band extension unit 150, the light emission unit 170, and the control unit 190 included in the wavelength swept source apparatus 100a of FIG. 1. Therefore, overlapping descriptions will be omitted.

The optical amplifier or optical attenuator 160 may be connected to an output terminal of the optical comb generation unit 130. The optical amplifier or optical attenuator 160 may adjust intensity of output light of the optical comb generation unit 130 according to a set gain value. When the optical amplifier is connected to the output terminal of the optical comb generation unit 130, the intensity of the output light of the optical comb generation unit 130 may be amplified. When the optical attenuator is connected to the output terminal of the optical comb generation unit 130, the intensity of the output light of the optical comb generation unit 130 may be attenuated. The optical amplifier or optical attenuator 160 may provide the amplified or attenuated output light of the optical comb generation unit 130 to the frequency band extension unit 150. However, it would be obvious that the optical amplifier or optical attenuator 160 may be used to amplify of attenuate intensity of output light of any component other than the optical comb generation unit 130. That is, the connecting the optical amplifier or optical attenuator 160 to the output terminal of the optical comb generation unit 130 is merely an example for describing the inventive concept.

The optical couplers 135 and 175 may be connected to output terminals of the optical amplifier or optical attenuator 160 and the light emission unit 170, respectively. The optical couplers 135 and 175 may split output light of the optical amplifier or optical attenuator 160 and the light emission unit 170, respectively. However, it would be obvious that only one of the optical couplers 135 and 175 may be connected to be used. However, it is assumed herein that both the optical couplers 135 and 175 are used, in order to help the understanding of the inventive concept.

The optical detectors 138 and 178 may receive the output light of the optical amplifier or optical attenuator 160 and the output light of the light emission unit 170, respectively, which have been split by the optical couplers 135 and 175, respectively. The optical detectors 138 and 178 may transform intensity of the output light of the optical amplifier or optical attenuator 160 and intensity of the output light of the light emission unit 170, respectively, into electric signals. Here, the electric signals obtained through the transformation by the optical detectors 138 and 178 may have a form of at least one of a voltage, a current, and power. Alternatively, the electric signals obtained through the transformation by the optical detectors 138 and 178 may have a form of a digital signal processed by an A/D converter (not shown).

The control unit 190 may receive the electric signals obtained through the transformation by the optical detectors 138 and 178. The control unit 190 may adjust a value of an amplification gain of the optical amplifier or optical attenuator 160, based on the electric signals. As the value of the amplification gain of the optical amplifier or optical attenuator 160 increases, intensity of the output light Sₒᵤₜ of the wavelength swept source apparatus 100c increases.

Therefore, since the value of the amplification gain of the optical amplifier or optical attenuator 160 is adjusted by the control unit 190, the intensity of the output light which is a performance index of the wavelength swept source apparatus 100c may reach a set target value. For example, when the intensity of the output light of the wavelength swept source apparatus 100c is weakened due to optical loss, the control unit 190 may control the optical amplifier or optical attenuator 160, so that the value of the amplification gain is increased.

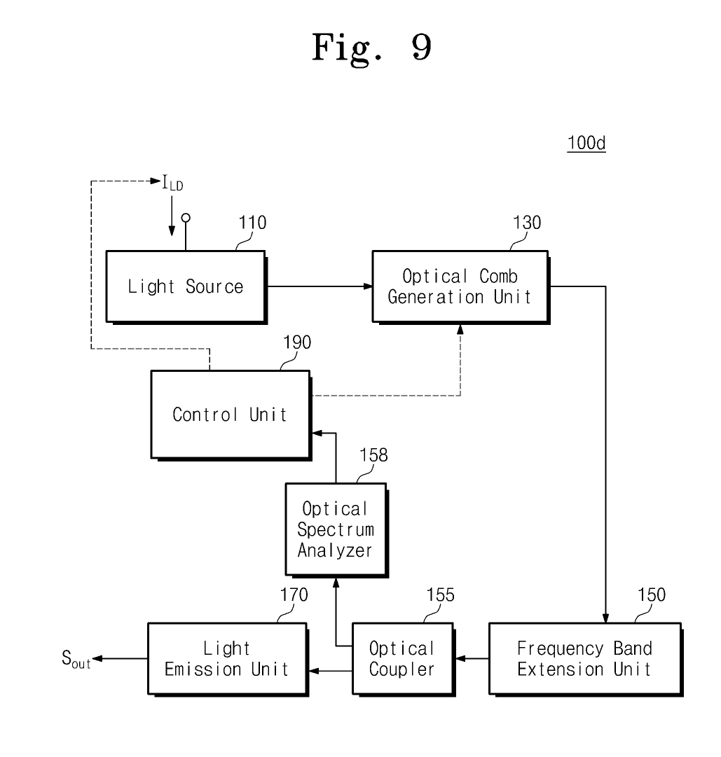

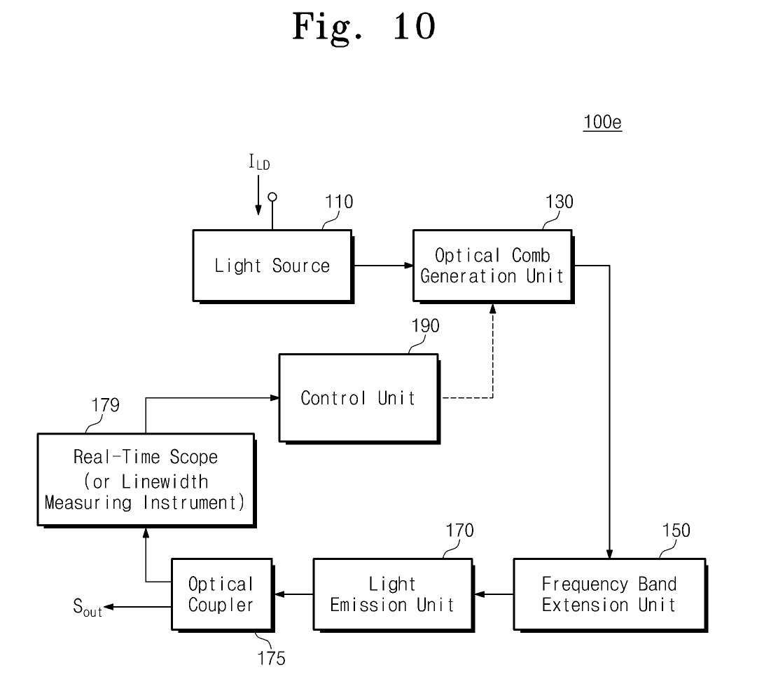

FIG. 9 is a block diagram illustrating other configuration of a wavelength swept source apparatus according to an embodiment of the inventive concept. A wavelength swept source apparatus 100d includes a light source 110, an optical comb generation unit 130, a frequency band extension unit 150, an optical coupler 155, an optical spectrum analyzer 158, a light emission unit 170, and a control unit 190. The light source 110, the optical comb generation unit 130, the frequency band extension unit 150, the light emission unit 170, and the control unit 190 have the same structures and functions as the light source 110, the optical comb generation unit 130, the frequency band extension unit 150, the light emission unit 170, and the control unit 190 included in the wavelength swept source apparatus 100a of FIG. 1. Therefore, overlapping descriptions will be omitted.

The optical coupler 155 may be connected to an output terminal of the frequency band extension unit 150. The optical coupler 155 may split output light of the frequency band extension unit 150. The optical coupler 155 may be a star-type coupler, a tree-type coupler, or a directional coupler.

The optical spectrum analyzer 158 may be provided with the output light of the frequency band extension unit 150 which has been split by the optical coupler 155. The optical spectrum analyzer 158 may calculate a frequency band Δω (refer to FIG. 5) in which the output light of the frequency band extension unit 150 is distributed. The calculated frequency band may have a form of an analog or digital signal.

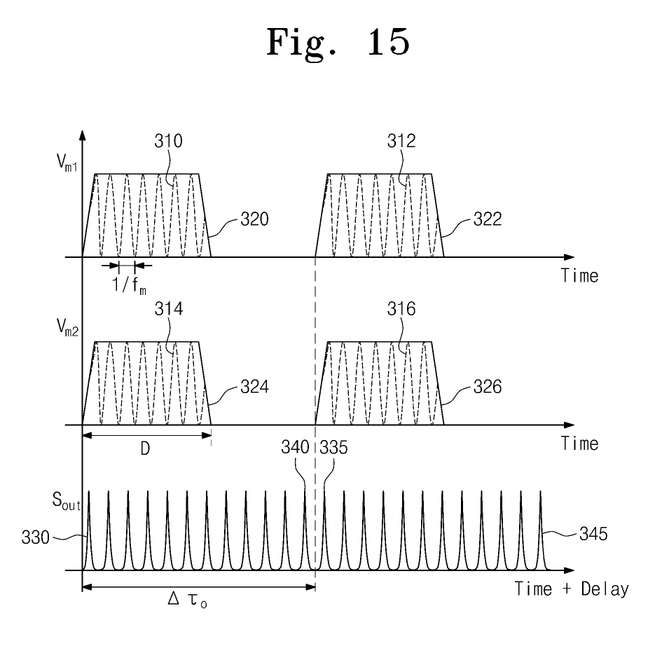

The control unit 190 may receive the frequency band calculated by the optical spectrum analyzer 158. The control unit 190 may adjust a value of a laser diode current I_{LD} provided to the light source 110, based on the calculated frequency band. Alternatively, the control unit 190 may adjust a value of a voltage applied to the optical comb generation unit 130, based on the calculated frequency band. Alternatively, the control unit 190 may adjust a modulation frequency fₘ (refer to FIG. 15) that determines, for instance, a form of the voltage applied to the optical comb generation unit 130, based on the calculated frequency band. The control unit 190 may simultaneously adjust two or more values of the foregoing control variable. The voltage applied to the optical comb generation unit 130 may be at least one of a first modulation voltage, a second modulation voltage, a first static voltage, and a second static voltage described above with reference to FIGS. 2 and 3. The voltage applied to the optical comb generation unit 130 may be provided by at least one of a function generator (not shown) and a voltage source (not shown).

As a frequency band in which output light of the wavelength swept source apparatus 100d is distributed becomes wider, an optical wavelength band swept by the wavelength swept source apparatus 100d may become wider. The frequency band in which the output light of the wavelength swept source apparatus 100d is distributed is affected by length, a nonlinear characteristic, and a dispersion characteristic of a medium forming the frequency band extension unit 150. However, the frequency band in which the output light of the wavelength swept source apparatus 100d is distributed may need to be adjusted. Since at least one of the value of the laser diode current, the value of the voltage applied to the optical comb generation unit 130, and the modulation frequency that determines, for instance, the form of the voltage applied to the optical comb generation unit 130 is adjusted by the control unit 190, the frequency band in which the output light of the wavelength swept source apparatus 100d is distributed may reach a set target value.

FIG. 10 is a block diagram illustrating other configuration of a wavelength swept source apparatus according to an embodiment of the inventive concept. A wavelength swept source apparatus 100e includes a light source 110, an optical comb generation unit 130, a frequency band extension unit 150, a light emission unit 170, an optical coupler 175, a real-time scope or linewidth measuring instrument 179, and a control unit 190. The light source 110, the optical comb generation unit 130, the frequency band extension unit 150, the light emission unit 170, and the control unit 190 have the same structures and functions as the light source 110, the optical comb generation unit 130, the frequency band extension unit 150, the light emission unit 170, and the control unit 190 included in the wavelength swept source apparatus 100a of FIG. 1. Therefore, overlapping descriptions will be omitted.

The optical coupler 175 may be connected to an output terminal of the light emission unit 170. The optical coupler 175 may split output light of the light emission unit 170. The optical coupler 175 may be a star-type coupler, a tree-type coupler, or a directional coupler.

The real-time scope or linewidth measuring instrument 179 may be provided with the output light of the light emission unit 170 which has been split by the optical coupler 175. The real-time scope or linewidth measuring instrument 179 may calculate an interval between a time at which a light ray having the highest frequency is emitted from the optical coupler 175 and a time at which a light ray having the lowest frequency is emitted from the optical coupler 175. The calculated interval may have a form of an analog or digital signal.

The control unit 190 may be provided with the interval calculated by the real-time scope or linewidth measuring instrument 179. The control unit 190 may adjust a modulation signal width D (refer to FIG. 15) that determines, for instance, a form of the voltage applied to the optical comb generation unit 130, based on the calculated interval. The voltage applied to the optical comb generation unit 130 may be at least one of a first modulation voltage, a second modulation voltage, a first static voltage, and a second static voltage described above with reference to FIGS. 2 and 3. The voltage applied to the optical comb generation unit 130 may be provided by at least one of a function generator (not shown) and a voltage source (not shown).

The modulation signal width needs to be smaller than the interval between the time at which the light ray having the highest frequency is emitted from the light emission unit 170 and the time at which the light ray having the lowest frequency is emitted from the light emission unit 170, so that periodic wavelength sweeping is appropriately performed. The control unit 190 may adjust the modulation signal width based on the interval between the time at which the light ray having the highest frequency is emitted from the light emission unit 170 and the time at which the light ray having the lowest frequency is emitted from the light emission unit 170. A relationship between the modulation signal width and the interval between the time at which the light ray having the highest frequency is emitted from the light emission unit 170 and the time at which the light ray having the lowest frequency is emitted from the light emission unit 170 will be described in more detail with reference to FIG. 15.

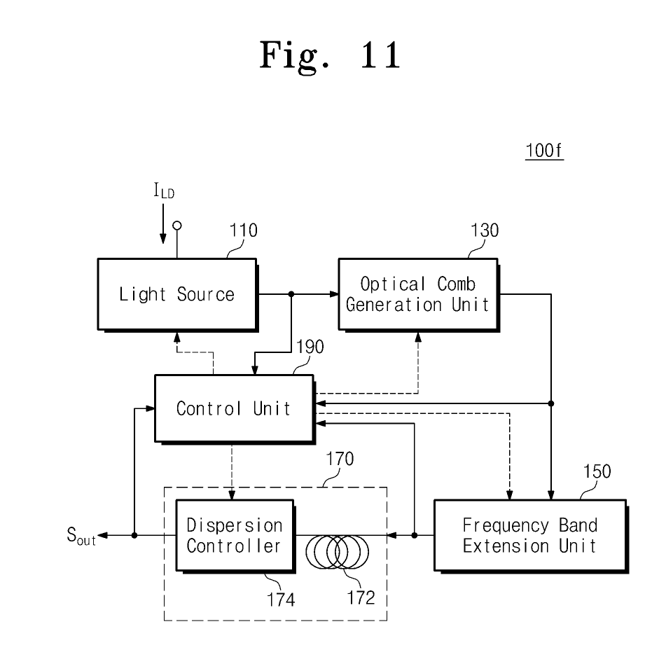

FIG. 11 is a block diagram illustrating other configuration of a wavelength swept source apparatus according to an embodiment of the inventive concept. A wavelength swept source apparatus 100f includes a light source 110, an optical comb generation unit 130, a frequency band extension unit 150, a light emission unit 170, and a control unit 190. The light source 110, the optical comb generation unit 130, the frequency band extension unit 150, the light emission unit 170, and the control unit 190 have the same structures and functions as the light source 110, the optical comb generation unit 130, the frequency band extension unit 150, the light emission unit 170, and the control unit 190 included in the wavelength swept source apparatus 100a of FIG. 1. Therefore, overlapping descriptions will be omitted.

The light emission unit 170 may include a dispersive fiber 172 and a dispersion controller 174. The dispersive fiber 172 may sequentially output the plurality of light rays included in the basic optical comb generated by the optical comb generation unit 130 and the light rays included in each of the plurality of optical combs generated by the frequency band extension unit 150, according to frequencies thereof. An interval between each time at which each of the light rays is emitted may be changed according to a dispersion characteristic of the dispersive fiber 172.

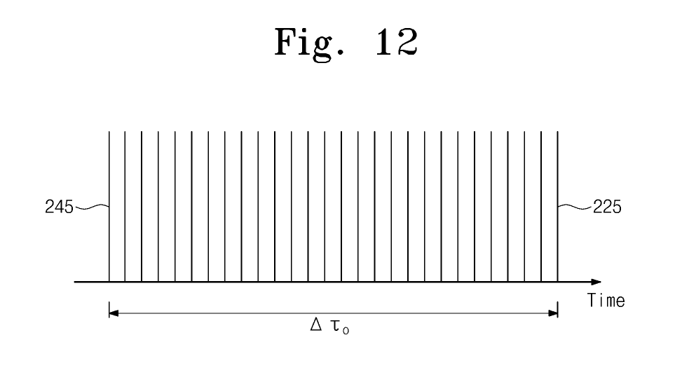

The dispersion controller 174 may control the interval between each time at which each of the light lays is emitted from the light emission unit 170. The interval between each time at which each of the light rays is emitted from the light emission unit 170 is greatly affected by the dispersion characteristic of the dispersive fiber 172. However, the interval between each time at which each of the light lays is emitted from the light emission unit 170 may need to be further adjusted, so that wavelength sweeping is appropriately performed. The dispersion controller 174 controls the interval between each time at which each of the light lays is emitted from the light emission unit 170. The dispersion controller 174 may be implemented in the form of an optical fiber or optical element including a chirped grating. A characteristic of the light rays emitted from the dispersion controller 174 will be described in more detail with reference to FIG. 12.

FIG. 12 is a graph illustrating a characteristic of light outputted from a dispersion controller that may be included in an embodiment of the inventive concept.

When the basic optical comb 210 (refer to FIG. 4) generated by the optical comb generation unit 130 (refer to FIG. 11) and the plurality of optical combs 220 to 240 (refer to FIG. 5) generated by the frequency band extension unit 150 (refer to FIG. 11) pass through the dispersive fiber 172 (refer to FIG. 11), each of the light rays is sequentially emitted. When the sequentially emitted light rays pass through the dispersion controller 174 (refer to FIG. 11), an interval between each time at which each of the light rays is emitted may be adjusted.

As a result, an interval Δτₒ between the time at which the light ray 245 having the highest frequency is emitted and the time at which the light ray 225 having the lowest frequency is emitted may be adjusted. That is, the interval between the time at which the light ray 245 having the highest frequency is emitted and the time at which the light ray 225 having the lowest frequency is emitted may be changed according to a case where the dispersion controller 174 is connected (i.e. Δτₒ) and a case where the dispersion controller 174 is not connected (i.e. Δτ_{g}, refer to FIG. 6).

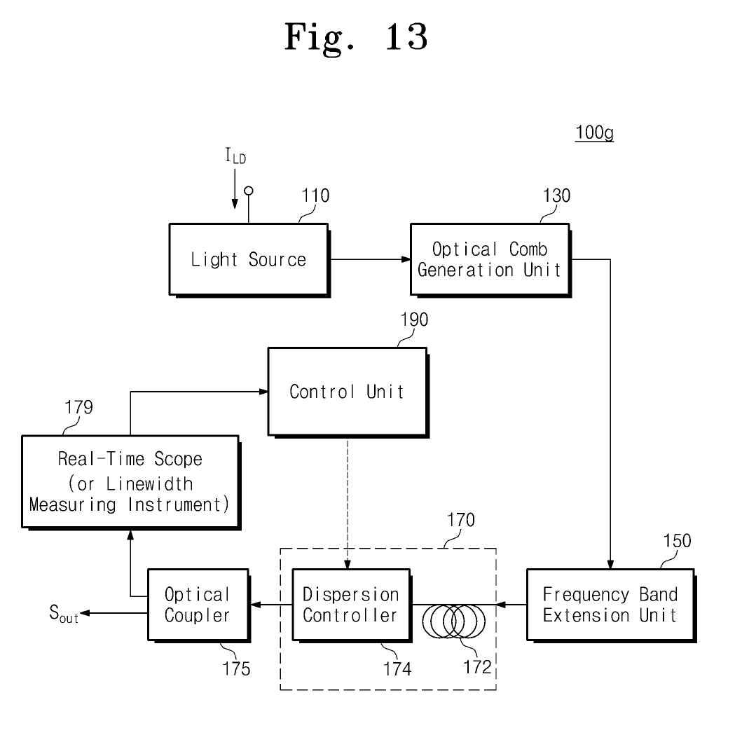

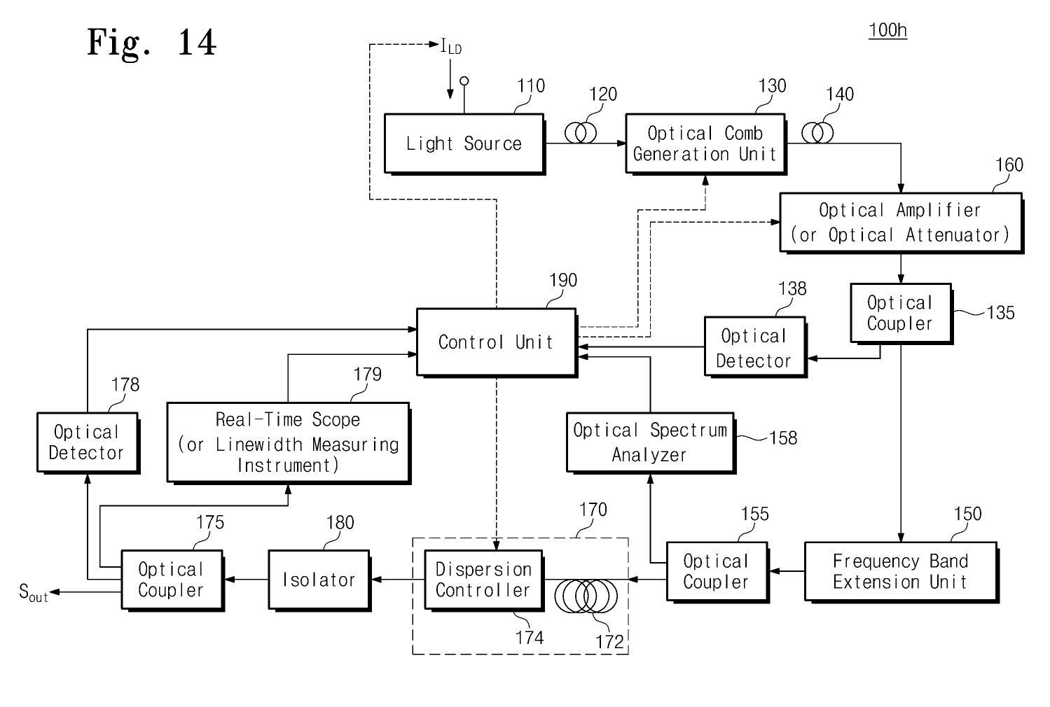

FIG. 13 is a block diagram illustrating another configuration of a wavelength swept source apparatus according to an embodiment of the inventive concept. A wavelength swept source apparatus 100g includes a light source 110, an optical comb generation unit 130, a frequency band extension unit 150, a light emission unit 170, an optical coupler 175, a real-time scope or linewidth measuring instrument 179, and a control unit 190. The light emission unit 170 may include a dispersive fiber 172 and a dispersion controller 174.

The light source 110, the optical comb generation unit 130, the frequency band extension unit 150, the light emission unit 170, and the control unit 190 have the same structures and functions as the light source 110, the optical comb generation unit 130, the frequency band extension unit 150, the light emission unit 170, and the control unit 190 included in the wavelength swept source apparatus 100a of FIG. 1. The dispersive fiber 172 and the dispersion controller 174 have the same structures and functions as the dispersive fiber 172 and the dispersion controller 174 included in the light emission unit 170 of FIG. 11. Therefore, overlapping descriptions will be omitted.

The optical coupler 175 may be connected to an output terminal of the light emission unit 170. The optical coupler 175 may split output light of the light emission unit 170. The optical coupler 175 may be a star-type coupler, a tree-type coupler, or a directional coupler.

The real-time scope or linewidth measuring instrument 179 may be provided with the output light of the light emission unit 170 which has been split by the optical coupler 175. The real-time scope or linewidth measuring instrument 179 may calculate an interval between a time at which a light ray having the highest frequency is emitted from the optical coupler 175 and a time at which a light ray having the lowest frequency is emitted from the optical coupler 175. The calculated interval may have a form of an analog or digital signal.

The control unit 190 may be provided with the interval calculated by the real-time scope or linewidth measuring instrument 179. The control unit 190 may adjust a value of a voltage applied to the dispersion controller 174, based on the calculated interval. The voltage applied to the dispersion controller 174 may be provided by a voltage source (not shown).

Basically, an interval between a time at which a light ray having the highest frequency is emitted from the wavelength swept source apparatus 100g and a time at which a light ray having the lowest frequency is emitted from the wavelength swept source apparatus 100g is affected by length and a dispersion characteristic of a medium forming the light emission unit 170. The wavelength swept source apparatus 100g may emit light rays from the light ray having the highest frequency to the light ray having the lowest frequency, and then may emit the light rays from the light ray having the highest frequency to the light ray having the lowest frequency again. This process is repeated at a certain period, so that periodic wavelength sweeping may be performed. However, the interval between the time at which the light ray having the highest frequency is emitted from the wavelength swept source apparatus 100g and the time at which the light ray having the lowest frequency is emitted from the wavelength swept source apparatus 100g may need to be adjusted. The control unit 190 may adjust an interval between each time at which each of light lays is emitted from the light emission unit 170 by adjusting the value of the voltage applied to the dispersion controller 174.

FIG. 14 is a block diagram illustrating another configuration of a wavelength swept source apparatus according to an embodiment of the inventive concept. A wavelength swept source apparatus 100h includes a light source 110, polarization controllers 120 and 140, an optical comb generation unit 130, an optical amplifier or optical attenuator 160, a frequency band extension unit 150, a light emission unit 170, optical couplers 135, 155, and 175, an isolator 180, optical detectors 138 and 178, an optical spectrum analyzer 158, a real-time scope or linewidth measuring instrument 179, and a control unit 190.

The wavelength swept source apparatus 100h of FIG. 14 is obtained by combining the components of the wavelength swept source apparatuses 100b, 100c, 100d, 100e and 100g of FIGS. 7 to 10 and 13. The light source 110, the optical comb generation unit 130, the optical amplifier or optical attenuator 160, the frequency band extension unit 150, the light emission unit 170, the optical couplers 135, 155, and 175, the optical detectors 138 and 178, the optical spectrum analyzer 158, the real-time scope or linewidth measuring instrument 179, and the control unit 190 have the same structures and functions as the corresponding components of FIGS. 7 to 10 and 13. Therefore, overlapping descriptions will be omitted.

The single mode light generated by the light source 110 is provided to the optical comb generation unit 130. The optical comb generation unit 130 generates the basic optical comb by modulating the single mode light. If the optical comb generation unit 130 has such characteristic that it passes a specific polarization component, the polarization controllers 120 and 140 may be connected to input and output terminals of the optical comb generation unit 130, respectively. The polarization controllers 120 and 140 may control a polarization characteristic of input light and/or output light of the optical comb generation unit 130.

The isolator 180 may block reflected light from outside of the wavelength swept source apparatus 100h. The isolator 180 may be connected to an output terminal of the light emission unit 170. The effect of the light reflected from the outside of the wavelength swept source apparatus 100h may be reduced by connecting the isolator 180.

The above-mentioned functions of the control unit 190 are merely examples for describing the inventive concept. Furthermore, the above-mentioned control variables are merely exemplary variables for controlling components. That is, each of the components may be controlled by other variables. Furthermore, the control unit 190 may be provided with other optical characteristics in order to adjust other control variables.

FIG. 15 is a graph illustrating a characteristic of a voltage applied to an optical comb generation unit and a characteristic of light emitted from a light emission unit according to an embodiment of the inventive concept. In particular, FIG. 15 illustrates general forms of a first modulation voltage Vₘ₁ and a second modulation voltage Vₘ₂ applied to the optical comb generation unit 130 (refer to FIG. 1) and the output light Sₒᵤₜ of the wavelength swept source apparatus 100a (refer to FIG. 1). Here, FIG. 15 illustrates a case where the optical comb generation unit 130 includes a DEMZM. In the case where the optical comb generation unit 130 includes an intensity modulator 136 (refer to FIG. 3) and a phase modulator 137 (refer to FIG. 3) connected to each other in series, only one modulation voltage is applied to the optical comb generation unit 130.

The first modulation voltage and the second modulation voltage need to be appropriately set, so that wavelength sweeping is performed by the light rays emitted from the light emission unit 170 (refer to FIG. 1) at every specific period of Δτₒ. The first modulation voltage and the second modulation voltage may be determined according to a modulation frequency fₘ and modulation signal width D. The control unit 190 (refer to FIG. 1) may adjust the modulation frequency and the modulation signal width.

The first modulation voltage may include modulation signals 310 and 312 (hereinafter referred to as optical comb generation signals) for generating an optical comb based on the single mode light, and may include signals 320 and 322 (hereinafter referred to as wavelength sweeping signals) for performing periodic wavelength sweeping. The optical comb generation signals 310 and 312 have the modulation frequency fₘ. Therefore, the optical comb generation signals 310 and 312 have a period corresponding to the reciprocal of the modulation frequency (i.e. 1/fₘ) in time domain.

The period of the wavelength sweeping signals 320 and 322 needs to be synchronized with the wavelength sweeping period Δτₒ of the light rays emitted from the light emission unit 170. In general, the modulation signal width D in which the wavelength sweeping signals 320 and 322 are applied needs to be greater than the reciprocal of the modulation frequency (i.e. 1/fₘ). Furthermore, the modulation signal width D needs to be greater than the time width Δτₛ (refer to FIG. 5) of the envelope of the output of the frequency band extension unit 150 (refer to FIG. 1) in time domain. Moreover, the modulation signal width D needs to be smaller than the wavelength sweeping period Δτₒ of the light rays emitted from the light emission unit 170, so that the periodic wavelength sweeping is appropriately performed.

The second modulation voltage may include optical comb generation signals 314 and 316 and wavelength sweeping signals 324 and 326. The first modulation voltage and the second modulation voltage may have the same modulation frequency fₘ and the same modulation signal width D, and may have different magnitude from each other. That is, the characteristics of the second modulation voltage are similar to those of the first modulation voltage. Thus, detailed descriptions of the second modulation voltage are omitted.

As an embodiment, an optical switch may be connected to the output terminal of the optical comb generation unit 130 of FIG. 1. If the switch is switched according to the wavelength sweeping period Δτₒ and the modulation signal width D, the wavelength sweeping signals 320, 322, 324, and 326 included in the first and second modulation voltages may be generated.

The output light Sₒᵤₜ of the wavelength swept source apparatus 100a may be obtained after a lapse of a certain period of time after the first and second modulation voltages are applied. This is because a delay occurs while the optical comb travels to an output terminal through a medium after the first and second modulation voltages are applied. The delay is reflected to the horizontal axis of the graph with respect to the output light Sₒᵤₜ.

The wavelength swept source apparatus 100a may sequentially emit light rays from light rays 330 and 335 having the highest frequency to light rays 340 and 345 having the lowest frequency. The output of the wavelength swept source apparatus 100a may have a specific period Δτₒ. That is, the wavelength swept source apparatus 100a may emit the light rays from the light ray 330 having the highest frequency to the light ray 340 having the lowest frequency, and then may emit the light rays from the light ray 335 having the highest frequency to the light ray 345 having the lowest frequency again. This process is repeated at the specific period Δτₒ, so that periodic wavelength sweeping may be performed.

The control unit 190 may appropriately adjust the value of the laser diode current I_{LD} (refer to FIG. 1), the values of the first and second modulation voltages, the modulation frequency fₘ, the modulation signal width D, and the value of the voltage applied to the dispersion controller 174 (refer to FIG. 7), so that the wavelength sweeping is performed at the specific period Δτₒ. However, the output order of the light rays 330 and 335 having the highest frequency and the light rays 340 and 345 having the lowest frequency may be reversed according to a sign of a dispersion coefficient of the light emission unit 170. That is, the graph with respect to the output light Sₒᵤₜ of FIG. 15 is merely an example for describing the inventive concept.

The above-mentioned wavelength swept source apparatus has a different structure from that of a typical wavelength swept source apparatus. The wavelength swept source apparatus according to an embodiment of the inventive concept has a simple structure and thus may be easily implemented. Furthermore, according to an embodiment of the inventive concept, a plurality of light rays having different frequencies may be emitted sequentially, stably and rapidly. Furthermore, according to the inventive concept, the wavelength swept source apparatus may be controlled so that wavelength sweeping is appropriately performed.

For example, if the wavelength swept source apparatus in which the frequency band extension unit 150 (refer to FIG. 1) is formed of a high nonlinear fiber (HNLF), a width of a wavelength area in which the optical comb outputted from the frequency band extension unit 150 is distributed is about 100 nm, the light emission unit 170 (refer to FIG. 1) is formed of an optical fiber of which a dispersion coefficient is about −50 ps/(km×nm) and length is 5 km, and the dispersion controller 174 (refer to FIG. 7) is not included is used, the wavelength sweeping period Δτₒ (refer to FIG. 9) of about 25 ns is obtained. That is, wavelength sweeping can be performed at a high speed according to a tuning rate of about 40 MHz.

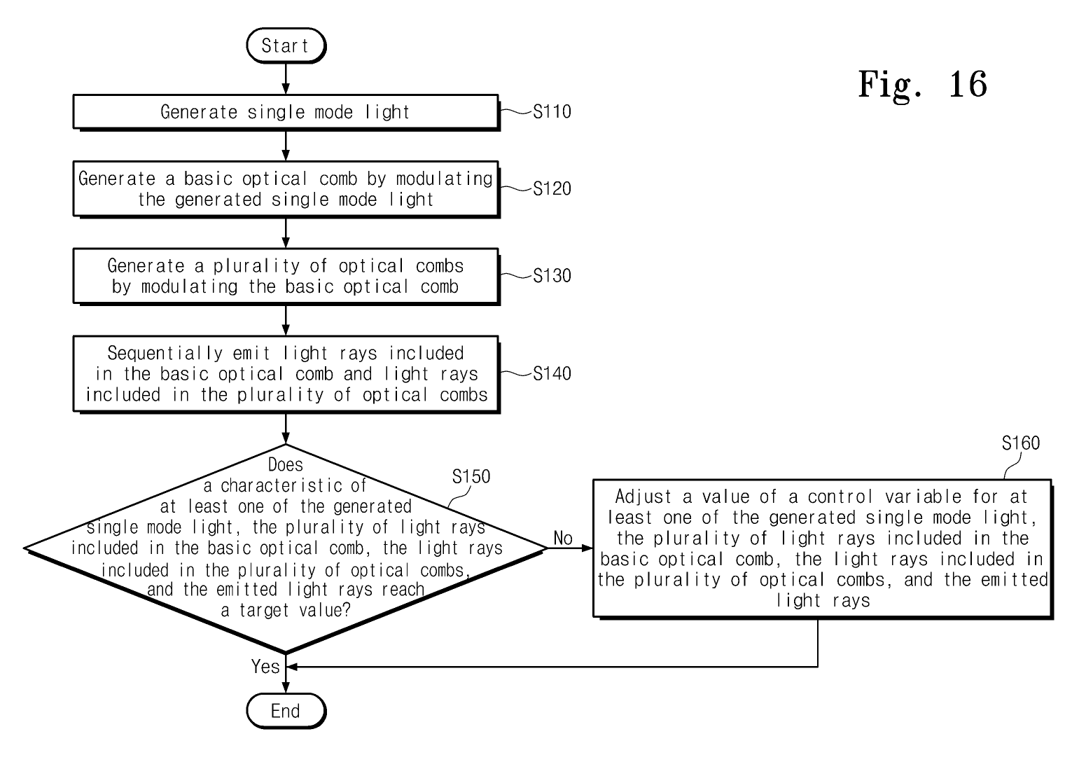

FIG. 16 is a flowchart illustrating a method for controlling a wavelength swept source apparatus according to other embodiment of the inventive concept.

In operation S110, single mode light may be generated. The single mode light may be generated by a longitudinal single mode laser diode.

In operation S120, a basic optical comb may be generated based on the single mode light. The basic optical comb includes a plurality of light rays having different frequencies. In the case where the basic optical comb is generated using the method of generating a harmonic wave through phase modulation, each of the plurality of light rays included in the basic optical comb may be a harmonic wave of the single mode light.

In operation S130, a plurality of optical combs may be generated based on the basic optical comb. Each of the plurality of optical combs includes light rays, the number of which is the same as that of the plurality of light rays included in the basic optical comb. There is a one-to-one correspondence between the light rays included in each of the plurality of optical combs and the plurality of light rays included in the basic optical comb. Frequency difference between a first light ray and a second light ray adjacent to the first light ray, among the plurality of light rays included in the basic optical comb, is the same as frequency difference between a light ray corresponding to the first light ray and a light ray corresponding to the second light ray, among the light rays included in each of the plurality of optical combs. Furthermore, a frequency band in which the plurality of light rays included in the basic optical comb are distributed and a frequency band in which the light rays included in each of the plurality of optical combs are distributed do not overlap each other. The plurality of optical combs may be generated according to a self-phase modulation characteristic of a medium.

In operation S140, the plurality of light rays included in the basic optical comb and the light rays included in each of the plurality of optical combs may be sequentially emitted. The plurality of light rays included in the basic optical comb and the light rays included in each of the plurality of optical combs may be sequentially emitted according to frequencies thereof. For instance, the plurality of light rays included in the basic optical comb and the light rays included in each of the plurality of optical combs may be sequentially emitted according to a group velocity dispersion characteristic of a medium.

In operation S150, it may be determined whether a characteristic of at least one of the single mode light, the plurality of light rays included in the basic optical comb, the light rays included in each of the plurality of optical combs, and the emitted light rays reaches a target value. One or more target values may be set with respect to characteristics of the single mode light, the plurality of light rays included in the basic optical comb, the light rays included in each of the plurality of optical combs, and the emitted light rays, so that wavelength sweeping is appropriately performed. When the characteristic of the light rays reaches the set target value, the method for controlling the wavelength swept source apparatus according to an embodiment of the inventive concept may be finished. On the other hand, operation S160 is performed if the characteristic of the light rays does not reach the set target value.

In the operation S160, a value of a control variable for at least one of the single mode light, the plurality of light rays included in the basic optical comb, the light rays included in each of the plurality of optical combs, and the emitted light rays may be adjusted. By adjusting the value of the control variable, the characteristic of the light rays may reach the set target value.

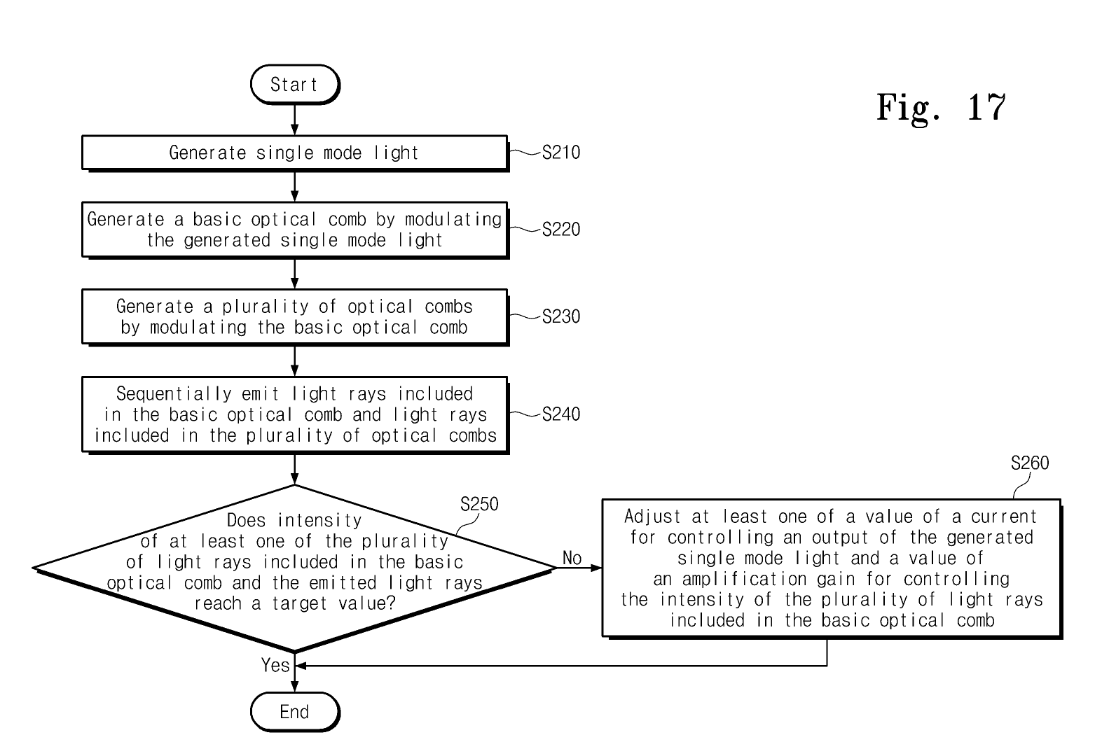

FIG. 17 is a detailed flowchart illustrating a method for controlling a wavelength swept source apparatus according to other embodiment of the inventive concept. Operations S210, S220, S230, and S240 may be the same as operations S110, S120, S130, and S140 of FIG. 16. Therefore, overlapping descriptions will be omitted.

In operation S250, it may be determined whether intensity of at least one of the plurality of light rays included in the basic optical comb and the emitted light rays reaches a target value. One or more target values may be set with respect to intensities of the plurality of light rays included in the basic optical comb and the emitted light rays, so that wavelength sweeping is appropriately performed. When the intensity of the plurality of light rays included in the basic optical comb and the emitted light rays reaches the set target value, the method for controlling the wavelength swept source apparatus according to an embodiment of the inventive concept may be finished. On the other hand, operation S260 is performed if the intensity of the plurality of light rays included in the basic optical comb and the emitted light rays does not reach the set target value.

In the operation S260, at least one of a laser diode current value for controlling the output of the single mode light and an amplification gain value for controlling the intensity of the plurality of light rays included in the basic optical comb may be adjusted. By adjusting at least one of the laser diode current value and the amplification gain value, the intensity of the plurality of light rays included in the basic optical comb and the emitted light rays may reach the set target value.

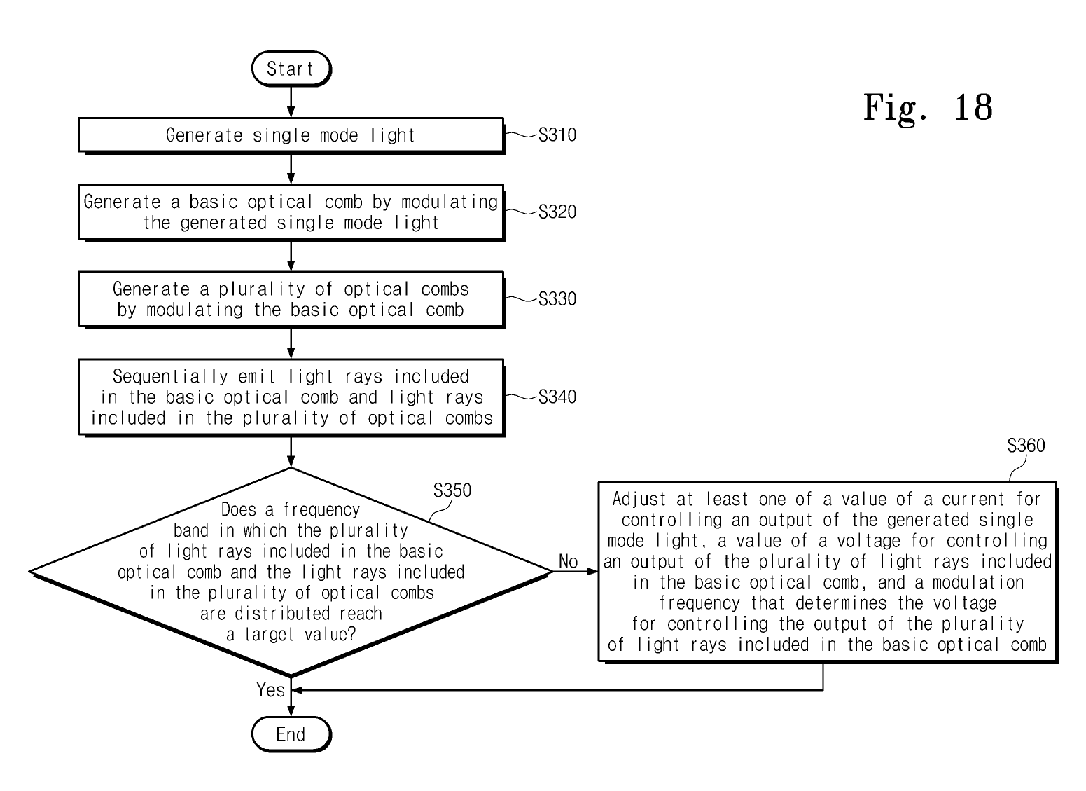

FIG. 18 is other detailed flowchart illustrating a method for controlling a wavelength swept source apparatus according to other embodiment of the inventive concept. Operations S310, S320, S330, and S340 may be the same as operations S110, S120, S130, and S140 of FIG. 16. Therefore, overlapping descriptions will be omitted.

In operation S350, it may be determined whether a frequency band in which the plurality of light rays included in the basic optical comb and the light rays included in each of the plurality of optical combs are distributed reaches a target value. One or more target values may be set with respect to the frequency band in which the plurality of light rays included in the basic optical comb and the light rays included in each of the plurality of optical combs are distributed, so that wavelength sweeping is appropriately performed. When the frequency band in which the plurality of light rays included in the basic optical comb and the light rays included in each of the plurality of optical combs are distributed reaches the set target value, the method for controlling the wavelength swept source apparatus according to an embodiment of the inventive concept may be finished. On the other hand, operation S360 is performed if the frequency band in which the plurality of light rays included in the basic optical comb and the light rays included in each of the plurality of optical combs are distributed does not reach the set target value.

In the operation S360, at least one of a value of a laser diode current for controlling the output of the single mode light, a value of a voltage for controlling the output of the plurality of light rays included in the basic optical comb, and a modulation frequency that determines, for instance, a form of the voltage for controlling the output of the plurality of light rays included in the basic optical comb may be adjusted. By adjusting at least one of the value of the laser diode current for controlling the output of the single mode light, the value of the voltage for controlling the output of the plurality of light rays included in the basic optical comb, and the modulation frequency that determines the form of the voltage for controlling the output of the plurality of light rays included in the basic optical comb, the frequency band in which the plurality of light rays included in the basic optical comb and the light rays included in each of the plurality of optical combs are distributed may reach the set target value.

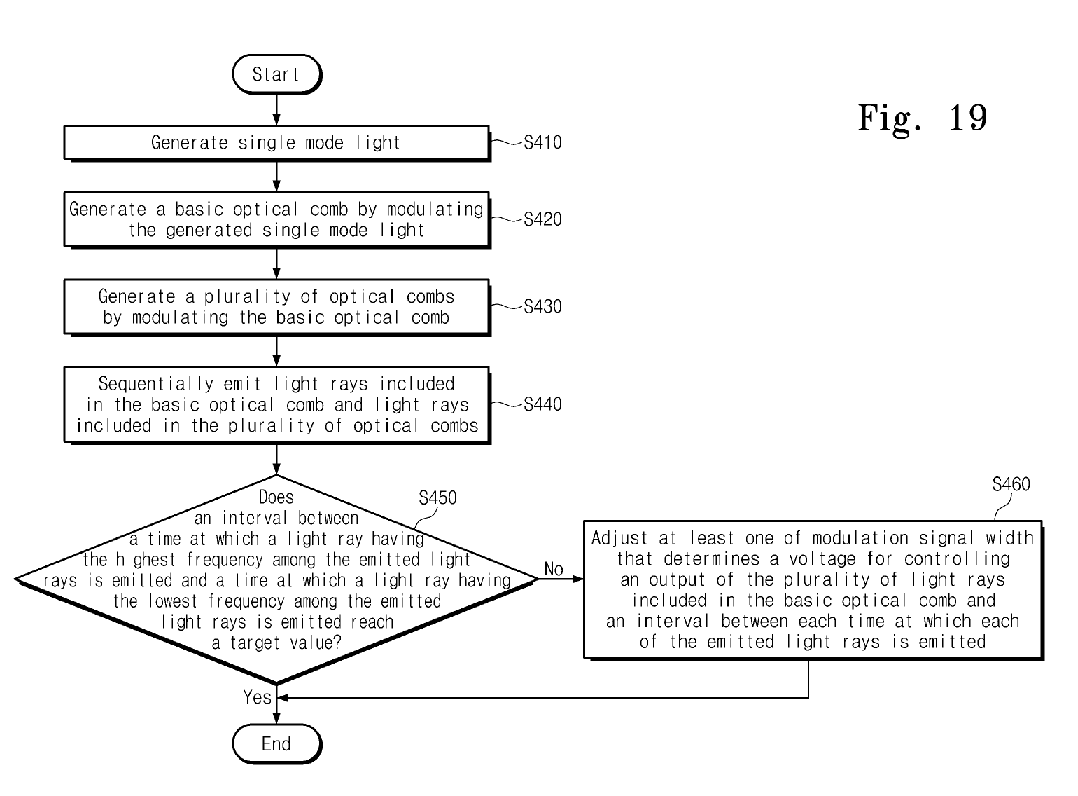

FIG. 19 is another detailed flowchart illustrating a method for controlling a wavelength swept source apparatus according to other embodiment of the inventive concept. Operations S410, S420, S430, and S440 may be the same as operations S110, S120, S130, and S140 of FIG. 16. Therefore, overlapping descriptions will be omitted.

In operation S450, it may be determined whether an interval between a time at which a light ray having the highest frequency among the emitted light rays is emitted and a time at which a light ray having the lowest frequency among the emitted light rays is emitted reaches a target value. One or more target values may be set with respect to the interval between the time at which the light ray having the highest frequency among the emitted light rays is emitted and the time at which the light ray having the lowest frequency among the emitted light rays is emitted, so that wavelength sweeping is appropriately performed. When the interval between the time at which the light ray having the highest frequency among the emitted light rays is emitted and the time at which the light ray having the lowest frequency among the emitted light rays is emitted reaches the set target value, the method for controlling the wavelength swept source apparatus according to an embodiment of the inventive concept may be finished. On the other hand, operation S460 is performed if the interval between the time at which the light ray having the highest frequency among the emitted light rays is emitted and the time at which the light ray having the lowest frequency among the emitted light rays is emitted does not reach the set target value.

In the operation S460, at least one of a modulation signal width that determines, for instance, a form of a voltage for controlling the output of the plurality of light rays included in the basic optical comb and an interval between each time at which each of the emitted light rays is emitted may be adjusted. By adjusting the modulation signal width that determines the form of the voltage for controlling the output of the plurality of light rays included in the basic optical comb and the interval between each time at which each of the emitted light rays is emitted, the interval between the time at which the light ray having the highest frequency among the emitted light rays is emitted and the time at which the light ray having the lowest frequency among the emitted light rays is emitted may reach the set target value.

According to the method for controlling the wavelength swept source apparatus of an embodiment of the inventive concept, a plurality of light rays having different frequencies may be emitted sequentially, stably and rapidly. Furthermore, the method for controlling the wavelength swept source apparatus of an embodiment of the inventive concept is not complicated and thus may be easily carried out. Moreover, target performance and output may be easily obtained using the method for controlling the wavelength swept source apparatus of an embodiment of the inventive concept.

The above-disclosed subject matter is to be considered illustrative, and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A wavelength swept source apparatus comprising:
a light source configured to generate single mode light;
an optical comb generation unit configured to generate a basic optical comb comprising a plurality of light rays having identical frequency differences with adjacent light rays by modulating the generated single mode light;
a frequency band extension unit configured to generate a plurality of optical combs by modulating the plurality of light rays, wherein each of the plurality of optical combs comprises same number of light rays as the plurality of light rays, each of the same number of light rays has identical frequency differences with adjacent light rays, each of the plurality of optical combs does not overlap the basic optical comb and has a different frequency band from that of the basic optical comb, and the plurality of optical combs is distributed in a wider frequency band than that in which the basic optical comb is distributed;
a light emission unit configured to sequentially emit the plurality of light rays and light rays included in the plurality of optical combs according to frequencies of the plurality of light rays and the light rays included in the plurality of optical combs; and
a control unit configured to adjust a value of a control variable for at least one of the light source, the optical comb generation unit, the frequency band extension unit, and the light emission unit, based on a characteristic of light outputted from at least one of the light source, the optical comb generation unit, the frequency band extension unit, and the light emission unit.

2. The wavelength swept source apparatus of claim 1, further comprising:
an optical coupler configured to split output light of at least one of the optical comb generation unit and the light emission unit; and
an optical detector configured to transform intensity of the split output light into an electric signal,
wherein the control unit adjusts a value of a current provided to the light source based on the transformed electric signal.

3. The wavelength swept source apparatus of claim 1, further comprising an optical amplifier or optical attenuator configured to adjust intensity of output light of the optical comb generation unit.

4. The wavelength swept source apparatus of claim 3, further comprising:
an optical coupler configured to split output light of at least one of the optical amplifier or optical attenuator and the light emission unit; and
an optical detector configured to transform intensity of the split output light into an electric signal,
wherein the control unit adjusts a gain value of the optical amplifier or optical attenuator based on the transformed electric signal.

5. The wavelength swept source apparatus of claim 1, further comprising:
an optical coupler configured to split output light of the frequency band extension unit; and
an optical spectrum analyzer configured to calculate a frequency band in which the split output light is distributed,
wherein the control unit adjusts at least one of a value of a current provided to the light source, a value of a voltage applied to the optical comb generation unit, and a modulation frequency that determines the voltage applied to the optical comb generation unit, based on the calculated frequency band.

6. The wavelength swept source apparatus of claim 1, further comprising:
an optical coupler configured to split output light of the light emission unit; and
a real-time scope or linewidth measuring instrument configured to calculate an interval between a time at which light having the highest frequency is emitted from the optical coupler and a time at which light having the lowest frequency is emitted from the optical coupler,
wherein the control unit adjusts modulation signal width that determines a voltage applied to the optical comb generation unit, based on the calculated interval.

7. The wavelength swept source apparatus of claim 1, wherein the light emission unit comprises a dispersion controller configured to adjust an interval between each time at which each of the plurality of light rays and the light rays included in the plurality of optical combs is emitted.

8. The wavelength swept source apparatus of claim 7, further comprising:
an optical coupler configured to split output light of the dispersion controller; and
a real-time scope or linewidth measuring instrument configured to calculate an interval between a time at which a light ray having the highest frequency is emitted from the optical coupler and a time at which a light ray having the lowest frequency is emitted from the optical coupler,
wherein the control unit adjusts a value of a voltage applied to the dispersion controller based on the calculated interval.

9. A method for controlling a wavelength swept source apparatus, the method comprising:
generating single mode light;
generating a basic optical comb comprising a plurality of light rays having identical frequency differences with adjacent light rays by modulating the generated single mode light;
generating a plurality of optical combs by modulating the plurality of light rays, wherein each of the plurality of optical combs comprises same number of light rays as the plurality of light rays, each of the same number of light rays has identical frequency differences with adjacent light rays, each of the plurality of optical combs does not overlap the basic optical comb and has a different frequency band from that of the basic optical comb, and the plurality of optical combs is distributed in a wider frequency band than that in which the basic optical comb is distributed;
sequentially emitting the plurality of light rays and light rays included in the plurality of optical combs according to frequencies of the plurality of light rays and the light rays included in the plurality of optical combs;
determining whether a characteristic of at least one of the generated single mode light, the plurality of light rays, the light rays included in the plurality of optical combs, and the emitted light rays reaches a target value; and
adjusting a value of a control variable for at least one of the generated single mode light, the plurality of light rays, the light rays included in the plurality of optical combs, and the emitted light rays, if the characteristic of at least one of the generated single mode light, the plurality of light rays, the light rays included in the plurality of optical combs, and the emitted light rays does not reach the target value.

10. The method of claim 9, wherein
the determining comprises determining whether intensity of at least one of the plurality of light rays and the emitted light rays reaches the target value, and
the adjusting comprises adjusting at least one of a value of a current for controlling an output of the generated single mode light and a gain value for controlling the intensity of the plurality of light rays.

11. The method of claim 9, wherein
the determining comprises determining whether a frequency band in which the plurality of light rays and the light rays included in the plurality of optical combs is distributed reaches the target value, and
the adjusting comprises adjusting at least one of a value of a current for controlling an output of the generated single mode light, a value of a voltage for controlling an output of the plurality of light rays, and a modulation frequency that determines the voltage for controlling the output of the plurality of light rays.

12. The method of claim 9, wherein
the determining comprises determining whether an interval between a time at which a light ray having the highest frequency among the emitted light rays is emitted and a time at which a light ray having the lowest frequency among the emitted light rays is emitted reaches the target value, and
the adjusting comprises adjusting at least one of modulation signal width that determines a voltage for controlling an output of the plurality of light rays and an interval between each time at which each of the emitted light rays is emitted.
